(19) United States
(12) Patent Application Publication
(10) Pub. No.: US 2009/0257061 A1
(43) Pub. Date: Oct. 15, 2009

(54) Optical Analyzer

(76) Inventor: Nils Wihlborg, Helsingborg, (SE)

Correspondence Address: HARNESS, DICKEY & PIERCE, P.L.C., P.O. BOX 8910, RESTON, VA, 20195, US

(21) Appl. No.: 11/991,634

(22) PCT Filed: Sep. 26, 2006
(86) PCT No.: PCT/EP2006/066746

§ 371 Date: May 14, 2008

(30) Foreign Application Priority Data
Nov. 25, 2005 (SE) 0502597-8

(51) Int. Cl. G01N 21/00

(52) U.S. Cl. 356/433

(57) ABSTRACT

An optical analyzer comprises a plurality of independent analysis zones (18a;18b), each for receiving an associated different sample and an optical system (24) including a first light source (26) adapted to generate a first optical beam (B₁) and an optical unit (30) adapted to direct said beam (B₁) to illuminate simultaneously two or more of the plurality of the analysis zones (18a;18b). A second light source (26) is also provided as part of the optical system (24) and is adapted to generate a second optical beam (B₂) to be directed by the optical unit (30) to illuminate simultaneously the same two or more of the plurality of analysis zones (18a;18b) simultaneously or sequentially illuminated by said first optical beam (B₁).

The present invention relates to an optical analyzer and in particular to an analyzer for simultaneous optical photometric measurements in multiple samples of a flow injection analyzer system.

It is known, from for example the commercially available FIASTAR™ 5000 system from FOSS Analytical A/S of Hilleroed, Denmark, to measure the amounts of total and free sulfur dioxide (SO₂) simultaneously in wine samples by means optical absorption. In this known system discreet sample volumes of a wine or other liquid vinefication product source are successively injected into two distinct, continuous, carrier streams. The sample volumes in each carrier stream react with stream specific reagents and a detector is provided for each carrier stream at an analysis zone, located downstream from the sample injection point. Each detector is configured to operate to register the results of the reaction as a so-called “sample measurement”.

In this known system the reagents are calorimetric reagents and the results of the reaction in each carrier stream thus manifest themselves as a color change in the respective samples. Each detector then operates to measure in the associated analysis zone intensity changes due to absorption of light by the sample. A first light source is used for each carrier stream and is adapted to emit in a wavelength region (or regions) sensitive to the color change. A second light source for each carrier stream is also used. This second source is adapted to emit light in a different wavelength region that is insensitive to the color change. Each detector also makes intensity related measurements (so-called “reference measurements” using this second source that are then employed in the system to correct the sample measurement absorption peak for background anomalies. A measurement unit correlates the corrected, measured absorption peak with the amount of either free or total SO₂, depending on the associated carrier stream, using a predetermined correlation relationship.

One problem with the known system is that in order for the measurements to be made simultaneously then the optical system needs to be duplicated for each carrier stream.

It is further known from, for example, U.S. 2003/0206297, to provide an optical analyzer for fluorescence correlation spectroscopy in which a light beam from a light source is incident on an optical system which divides this light beam into a plurality of separate beams. Each beam is directed to illuminate a different analysis zone in the form of a respective sample well in a multiple well plate. Individual detectors are provided, one for each illuminated analysis zone.

According to the present invention there is provided an optical analyzer as described in and characterized by the present Claim 1. By arranging for the plurality of independent analysis zones, such as may be provided by a flow injection system, to be simultaneously illuminated by light from two sources, activated simultaneously or sequentially, during the making of sample, and optionally reference, measurements then the number of optical components and the complexity of the optical system may both be reduced.

Usefully, a beam splitter may be employed to generate transmitted and reflected portions for simultaneously illuminating the plurality of analysis zones. This provides for a relative inexpensive and mechanically robust analyzer.

These and other advantages will be made clear from a reading of the following description of exemplary embodiments of the analyzer according to the present invention and made with reference to the drawings of the accompanying figures, of which:

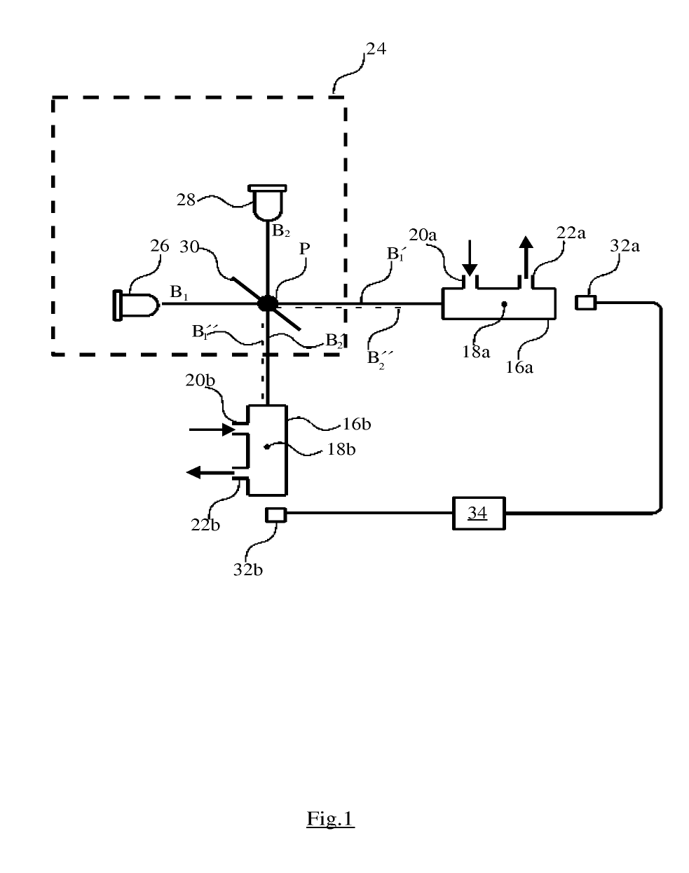

FIG. 1 shows schematically an embodiment of an optical system of an analyzer according to the present invention;

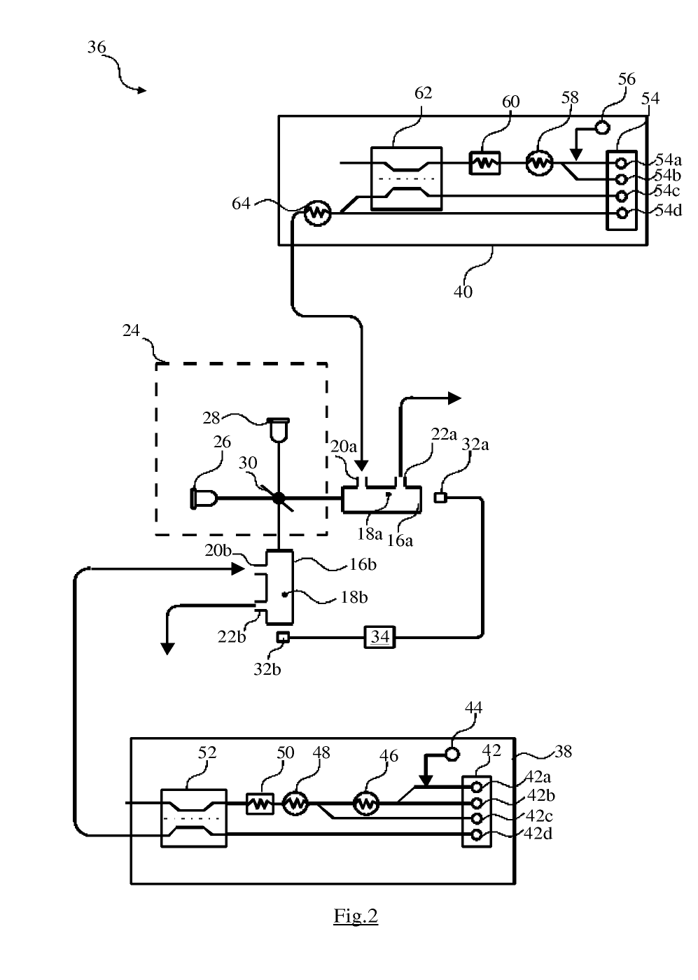

FIG. 2 shows schematically the embodiment of FIG. 1 used with a flow injection analyzer for SO₂ measurements in wine.

Considering now an embodiment of an optical analyzer according to the present invention as is illustrated schematically in FIG. 1. The analyzer comprises two substantially identical liquid retaining cells 16a,b that each forms internally a respective independent analysis zone 18a,b. Each cell 16a,b is formed with a respective liquid inlet 20a,b and a liquid outlet 22a,b and may be employed to hold stationary a liquid sample during the generation of a sample measurement or to allow the liquid sample to flow between the inlet 20a,b and the outlet 22a,b during the generation of a sample measurement, depending on the intended application.

The analyzer further comprises an optical system 24 that is here adapted to generate a first optical beam B₁ for simultaneously illuminating the analysis zones 18a,b to thereby enable a sample measurement to be made and to generate a second optical beam B₂ for simultaneously illuminating the analysis zones 18a,b to thereby enable a reference measurement to be made.

The optical system 24 of the present invention comprises a first light source 26 and a second light source 28, which in the present embodiment are realized using light emitting diodes (LEDs) that generate respective optical beams B₁,B₂ in selected narrow wavelength regions (optionally an appropriate optical filter (not shown) may also be employed). One source, here the first source 26, is in the present embodiment arranged to generate the optical beam B₁ in a wavelength region sensitive to calorimetric changes as described further below. The other source, here the second source 28, is in the present embodiment arranged to generate the optical beam B₂ which is substantially insensitive to the below described calorimetric change. An optical unit 30 is also provided as an element of the optical system 24 and is configured to sequentially or simultaneously direct light from each of the sources 26,28 to illuminate simultaneously the independent analysis zones 18a,18b by employing the same optical components for each source 26,28.

In the present optical system 24 the two light sources 26,28 are arranged to generate respective optical beams B₁,B₂ along orthogonal and intersecting paths and the optical unit comprises 50% beamsplitter 30 located at the point P of their intersection. By 50% beamsplitter it is meant an optical component configured to split a single incident beam into two beams of substantially equal intensity from a single incident beam.

The beamsplitter 30 is orientated (here at an angle of 45° to the orthogonal beams B₁,B₂) such that the transmitted portion B₁′ of the incident first optical beam B₁ traverses substantially the same path as the reflected portion B₂′′ of the incident second optical beam B₂ to illuminate the same analysis zone 18a. In this orientation the reflected portion B₁′′ of the incident first optical beam B₁ traverses substantially the same path as the transmitted portion B₂′ of the incident second optical beam B₂ to illuminate the same analysis zone 18b. In this manner a compact optical system 24 may be formed.

Also provided as part of the analyzer are detectors 32a,b, one for each analysis zone 18a,b, to monitor the intensity of optical beams passing through a sample in the respective cells 16a,b. Each detector 32a,b is here shown having an output connected to a measurement unit 34, which output in the present embodiment provides a signal to the unit 34 representative of the respective monitored intensity. The measurement unit 34, including for example a programmable microprocessor, is configured to correlate the outputs with an amount of component of interest in a respective sample in the analysis zone 18a,b of the respective cell 16a,b using, in a known manner, a predetermined correlation relationship. This correlation relationship may be generated in a known fashion by indexing measured absorbance intensities with known amounts of the substance(s) of interest in a sample. The amount of the substance(s) of interest may be determined by simply adding a known amount to a substance-free sample or by direct measurement (such as chemical analysis) of the substance(s) of interest in the sample.

Consider now, by way of example only, the inclusion of the arrangement of FIG. 1 in a Flow Injection Analyzer (FIA) for measuring the amounts of free and total SO₂ in a vinefication product, such as wine.

The basic FIA measurement principles are well known and are employed in, for example, the aforementioned FIASTAR™ 5000 instrument. In this instrument in order to determine total SO₂ the wine sample is injected into a pH 8.4 phosphate buffer solution. Known 5,5′-Dithio-bis(2-nitrobenzoic acid)—so called “DTNB”—colourometric reagent is then added and the stream is heated to 50° C. The DTNB reacts with all forms of SO₂ and produces a strong yellow color which is dialysed into a suitable absorbance range. The final color is measured at 420 nm. In order to determine free SO₂ a sample from the same liquid source is injected into a water carrier and is then acidified with hydrochloric acid to liberate sulphur dioxide gas from the sample. This SO₂ gas (Free SO₂) diffuses through a gas permeable membrane into a pH 8.4 phosphate buffer solution. DTNB reagent is then added and reacts with the Free SO₂. The color reaction produces a strong yellow color, which is again measured at 420 nm.

The FIA 36, illustrated schematically in FIG. 2, comprises a first flow injection unit 38 provided for the measurement of total SO₂ and a separate, second flow injection unit 40 provided for the measurement of Free SO₂. These units 38,40 operate in a conventional manner according to the method described above and so only the basic exemplary flow scheme of each unit 38,40 will be described in sufficient detail to allow an understanding of the operation of the remaining functional units of the FIA 36.

Considering now the first flow injection unit 38, a source of liquid reagents 42 is provided which comprises a carrier 42a (here the phosphate buffer); a first reagent 42b (here the phosphate buffer); a second reagent 42c (here the DNTB); and a third reagent 42d(here de-ionized water). A sample injector 44 is provided for injecting a volume of the sample into the carrier stream 42a from the source 42. This is then mixed together with the first reagent 42b in a mixer coil 46. The second reagent 42c is then added to the sample/carrier stream and mixed in a mixer coil 48. This sample/carrier is then passed to a third, heated mixer coil 50 where the sample/carrier stream is heated to around 50° C. and passed through a dialyzer 52 where the sample/carrier stream is dialyzed to a suitable color before being passed through the inlet 20b of the flow cell 16b for measurement and then through the outlet 22b to a waste system (not shown).

Considering now the second flow injection unit 40, a source of liquid reagents 54 is provided comprising a carrier 54a (here the de-ionized water); a first reagent 54b (here the hydrochloric acid); a second reagent 54c (here the phosphate buffer); and a third reagent 54d (here the DNTB). A sample injector 56 is provided for injecting a volume of the sample into the carrier stream 54a from the source 54. This is then mixed together with the first reagent 54b in a mixer coil 58 and this sample/carrier further mixed in a heated mixer coil 60 where it is heated to around 35° C. in order to liberate Free SO₂. This Free SO₂ then diffuses through a gas permeable membrane of a dialyzer 62 and into the second reagent 54c. This is then mixed with the third reagent 54d in a mixer 64 and a color reaction produces a strong yellow color. This reacted sample/carrier stream is passed through the inlet 20a of the flow cell 16a for measurement and then through the outlet 22a to the waste system (not shown).

The operation of the two flow injection units 38,40 of the present embodiment is arranged such that the individual samples are simultaneously present in both analysis zones 18a,b of their respective flow cells 16a,b.

The LEDs 26,28 of the optical system 24 are driven in sequence to illuminate samples in the respective analysis zones 18a,18b in parallel with associated first and second optical beams. In the present embodiment the LED 26 is chosen to emit a narrow wavelength band sensitive to the color change of the calorimetric reagent(here in the region of 420 nm) as the first optical Beam B₁. This beam impinges the beamsplitter 30 where it is divided so as to pass through both analysis zones 18a,b in parallel. Detectors 32a,b each record the amplitude of incident light from the LED 26 after its interaction with respective samples in the associated analysis zones 18a,b to generate a sample measurement signal as an output to the measurement unit 34. The LED 28 is, in the present embodiment, chosen to emit a narrow wavelength band that is insensitive to the color change (here in the region of 720 nm) as the second optical Beam B₂. This beam impinges the beamsplitter 30 where it is divided so as to pass through both analysis zones 18a,b in parallel. Detectors 32a,b each record the amplitude of incident light from the LED 28 after its interaction with respective same samples in the associated analysis zones 18a,b to generate a reference measurement signal for that same sample as an output to the measurement unit 34.

The measurement unit 34 is configured, for example through suitable programming, correct the sample measurement signal associated with each flow cell 16a,b independently with the reference measurement signal associated with the same flow cell 16a,b to generate a respective corrected sample measurement for a sample in each flow cell 16a,b (here representing total SO₂ (16b) and Free SO₂ (16a)). This may be done simply by subtracting the reference measurement signal from the sample measurement signal from each detector 32a,b. The measurement unit 34 is further configured to correlate the corrected, measured absorption peak with the amount of either Free or total SO₂, depending on the associated carrier stream, using a predetermined correlation relationship, typically a linear relationship, in a known manner.

It will be appreciated by those skilled in the art that the FIA 36 described above may be readily adapted to provide simultaneous colorimetric based monitoring of different components in other sample types using appropriate reagents, for example nitrate and nitrite ions in water, and to provide more than two distinct carrier streams without departing from the invention as claimed.

Further the same components in the same sample type may be monitored using a different known calorimetric reagent, for example Manganese II, p-aminoazobenzene or bromocresol green, and LEDs emitting in appropriate wavelength regions without departing from the invention as claimed.

1. An optical analyzer comprising a plurality of independent analysis zones (18a;18b), each for receiving an associated different sample; an optical system comprising a first light source adapted to generate a first optical beam (B1) and an optical unit adapted to direct said beam (BI) to illuminate simultaneously two or more of the plurality of the analysis zones (18a 18b); characterised in that the optical system further comprises a second light source adapted to generate a second optical beam (B2) and in that the optical unit is adapted to also direct said second optical beam (B2) to illuminate simultaneously the same two or more of the plurality of analysis zones (18a;18b) simultaneously or sequentially illuminated by said first optical beam (B1).

2. An optical analyser as claimed in claim 1 wherein the optical unit of the optical system comprises at least on beam splitter upon which said first (B1) and second, (B2) optical beams are incident and which is configured to provide for each incident optical beam (B1;B2) an associated reflected (B1″;B2″) and transmitted (B1′; B2′) portion along different optical paths for simultaneously illuminating a different one of the plurality of analysis zones (18a; 18b).

3. An optical analyser as claimed in claim 2 wherein the optical system comprises a first light source and a second light source adapted to emit respectively said first (B1) and said second (B2) optical beams along orthogonal and intersecting optical paths and in that the beam splitter is arranged at the intersection (P) of the optical paths.

4. An optical analyser as claimed in claim 1 wherein the analyser further I comprises a flow injection system configured to provide at least two distinct carrier streams into each one of which a sample volume is to be injected an transported to an associated independent analysis zone (18a;18b) for illumination by said first optical team (Bi) and said second optical beam (B2.).

5. An optical analyser as claimed in claim 4 wherein the flow inject on system comprises two independent flow injection units (38;40), each disposed to provide a one of the distinct carrier streams and each adapted to monitor a different one of total and free sulphur dioxide content of a vinefication product.
